(19) United States
(12) Patent Application Publication
(10) Pub. No.: US 2021/0022362 A1
(43) Pub. Date: Jan. 28, 2021

(54) Non-Hydrogenated Fat Composition, Use and Process

(71) Applicant: Bunge Loders Croklaan B.V., Wormerveer (NL)

(72) Inventors: Jun Ma, Wormerveer (NL); Raul-Flaviu Petrut, Wormerveer (NL)

(73) Assignee: Bunge Loders Croklaan B.V., Wormerveer (NL)

(21) Appl. No.: 16/982,158

(22) PCT Filed: Mar. 21, 2019
(86) PCT No.: PCT/EP2019/057082

§ 371 Date: Sep. 18, 2020

(30) Foreign Application Priority Data
Mar. 27, 2018 (EP) 18164428.7

(51) Int. Cl. A23D 9/02; C11C 3/10

(52) U.S. Cl. CPC A23D 9/02; A23L 9/22; C11C 3/10

(57) ABSTRACT

A non-hydrogenated fat composition comprises: from 3.2% to 10% by weight of total caprylic acid (C8:0) and capric acid (C10:0); from 13% to 32% by weight lauric acid; and from 20% to 45% by weight stearic acid (C18:0) fatty acid residues; the percentages of acids referring to acids bound as acyl groups in glycerides in the fat composition and being based on the total weight of C8 to C24 fatty acids; and from 7% to 15% by weight CN46 triglycerides; from 4% to 30% by weight CN54 triglycerides; and from 15% to 28% by weight of total CN42 triglycerides and CN44 triglycerides; the percentages of triglycerides referring to the total triglycerides present in the composition.

This invention relates to a non-hydrogenated fat composition, uses thereof and a process to produce such fat composition.

### BACKGROUND

Lauric oils, such as coconut oil, are vegetable oils comprising predominantly short- and medium chain fatty acid (caprylic acid (C8:0), capric acid (C10:0), lauric acid (C12:0) and myristic acid (C14:0)). Lauric oils are extensively used in the food industries, where the uses include filling cream, ice cream, non-dairy whipped cream, coffee whiteners, cacao butter substitutes and medium chain triglycerides (MCTs).

Shea butter is a fat obtained from the nuts of the shea tree (Vitellaria paradoxa). Shea butter is relatively rich in stearic acid (C18:0) and oleic acid (C18:1). Shea butter is often fractionated to form shea stearin and shea olein. Shea products are used in both cosmetics and food industry. Shea stearin is rich in StOSt (1,3-distearoyl-2-oleoyl glyceride) and often used as a cacao butter equivalent.

Fats and oils are important ingredients of food products. Fats and oils contain glycerides, predominantly triglycerides. Fats and oils are occasionally subjected to an interesterification process which randomly redistributes the fatty acid acyl residues amongst the glyceride molecules. This process can alter the physical properties of the fat or oil, such as melting point.

WO 2012/052471 describes several interesterified blends of lauric oil and non-lauric oil used in an edible product containing 15-80% of triglycerides, 20-85% of filler and at most 15% water.

WO 2016/162529 describes the blend of high oleic sunflower oil and the interesterified fat of lauric oil and shea component, used in a deep fried food product comprising from 2 to 45 percent by weight of a frying oil or fat.

WO 2014/020114 describes various interesterified blends of fully hydrogenated oil, lauric oil, liquid oil, and other fats which may contain shea component. The fat composition allows the preparation of a fat spread composition lowering the cholesterol level in human beings.

### DESCRIPTION OF THE INVENTION

There remains a need to improve the performance of fat compositions as food ingredients, which are suitable for food applications such as bakery and/or confectionery. There also remains a need to improve the texture of food by using fat compositions as food ingredients in order to improve the sensory performance.

According to the present invention, there is provided a non-hydrogenated fat composition comprising from 3.2% to 10% by weight of total caprylic acid (C8:0) and capric acid (C10:0); from 13% to 32% by weight lauric acid (C12:0); and from 20% to 45% by weight stearic acid (C18:0) fatty acid residues; the percentages of acids referring to acids bound as acyl groups in glycerides in the fat composition and being based on the total weight of C8 to C24 fatty acids; and from 7% to 15% by weight CN46 triglycerides; from 4% to 30% by weight CN54 triglycerides; and from 15% to 28% by weight of total CN42 triglycerides and CN44 triglycerides; the percentages of triglycerides referring to the total triglycerides present in the composition.

The fat composition of this invention has been found to be particularly useful as an ingredient for bakery and/or confectionery applications. Fat compositions according to the invention provide particularly favorable sensory properties. The compositions can provide texture properties that are desirable in confectionery and/or bakery applications. In particular, the fat composition provides good physical properties to allow the incorporation of more air in whipped cream in order to obtain a desirable texture and sensory performance.

The fat composition of the invention may be made from naturally occurring or synthetic fats, fractions of naturally occurring or synthetic fats, or mixtures thereof, that satisfy the requirements for fatty acids and triglycerides composition defined herein. Preferably, the fat composition is derived from a blend of naturally occurring fats.

The term “fat” refers to glyceride fats and oils containing fatty acid acyl groups and does not imply any particular melting point. The term “oil” is used synonymously with “fat”.

The term “non-hydrogenated” means that the composition is not prepared from a fat that has been subjected to hydrogenation to convert unsaturated fatty acyl groups to saturated fatty acyl groups. The requirement for the fat to be non-hydrogenated means that the content of trans fatty acid residues in the composition is typically less than 1% by weight based on total C8 to C24 fatty acids present, more preferably less than 0.5% by weight.

The term “fatty acid”, as used herein, refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. Percentages of fatty acids in compositions referred to herein include acyl groups in tri-, di- and mono-glycerides present in the glycerides and are based on the total weight of C8 to C24 fatty acids. The fatty acid profile (i.e., composition) may be determined, for example, by fatty acid methyl ester analysis (FAME) using gas chromatography according to ISO 12966-2 and ISO 12966-4.

Triglyceride content may be determined for example based on molecular weight differences (Carbon Number (CN)) by GC (AOCS Ce 5-86). The notation triglyceride CNxx denotes triglycerides having xx carbon atoms in the fatty acyl groups e.g., CN54 includes tristearin. Amounts of triglycerides specified with each carbon number (CN) as is customary terminology in the art are percentages by weight based on total triglycerides of CN26 to CN62 present in the fat composition.

The fat composition of this invention contains from 3.2% to 10% by weight of total caprylic acid (C8:0) and capric acid (C10:0) based on the total weight of C8 to C24 fatty acids. The fat composition preferably contains from 3.5% to 8% by weight of total caprylic acid (C8:0) and capric acid (C10:0), more preferably from 3.5% to 6% by weight of total caprylic acid (C8:0) and capric acid (C10:0).

The lauric acid (C12:0) content of the fat composition of the invention is from 13% to 32% by weight based on the total weight of C8 to C24 fatty acids, preferably from 14% to 30% by weight, more preferably from 15% to 28% by weight.

The stearic acid (C18:0) content of the fat compositions of the invention is from 20% to 45% by weight based on the total weight of C8 to C24 fatty acids, preferably from 23% to 43% by weight, more preferably from 25% to 41% by weight.

The palmitic acid (C16:0) content of the fat composition of the invention is preferably less than 12% by weight based on the total weight of C8 to C24 fatty acids, more preferably less than 10% by weight, such as from 1% to 9% by weight.

The weight ratio of stearic acid (C18:0) to palmitic acid (C16:0) in the fat composition is preferably in the range of from 5:2 to 9:1, more preferably from 3:1 to 8:1, even more preferably from 3.1:1 to 7:1.

The weight ratio of lauric acid (C12:0) to stearic acid (C18:0) in the fat composition is preferably in the range of from 1:3.5 to 2:1, preferably from 1:3.3 to 3:2, more preferably from 1:3 to 1:1.

A preferred fat composition of the invention therefore comprises, based on the total weight of C8 to C24 fatty acids: from 3.5% to 8% by weight of total caprylic acid (C8:0) and capric acid (C10:0); from 14% to 30% by weight lauric acid (C12:0); and from 23% to 43% by weight stearic acid (C18:0); wherein the weight ratio of stearic acid (C18:0) to palmitic acid (C16:0) is from 3:1 to 8:1; and the weight ratio of lauric acid (C12:0) to stearic acid (C18:0) is from 1:3.3 to 3:2, said percentages and ratios of acids referring to acids bound as acyl groups in glycerides in the fat composition and said percentages being based on the total weight of C8 to C24 fatty acids.

The fat composition of the invention comprises from 7% to 15% by weight CN46 triglycerides, from 4% to 30% by weight CN54 triglycerides and from 15% to 28% by weight of total CN42 triglycerides and CN44 triglycerides, based on total triglycerides present in the composition. Such compositions can provide advantageous structural properties usable in bakery and confectionery applications.

Preferably, the fat composition comprises from 8% to 12%, more preferably from 8% to 10% by weight CN46 triglycerides, based on total triglycerides present in the composition. Preferably, the fat composition comprises from 8% to 25%, more preferably from 10% to 22% by weight CN54 triglycerides, based on total triglycerides present in the composition. The sum of CN42 triglycerides and CN44 triglycerides in the fat composition is preferably in the range of from 18% to 27%, more preferably from 19% to 26%, based on total triglycerides present in the composition.

Accordingly, a preferred triglyceride composition for the fat composition of the invention comprises: from 8% to 12% by weight CN46 triglycerides; from 8% to 25% by weight CN54 triglycerides; and from 18% to 27% by weight of total CN42 triglycerides and CN44 triglycerides; based on total triglycerides present in the composition.

In a most preferred embodiment of the invention, the fat composition comprises: from 3.5% to 6% by weight of total caprylic acid (C8:0) and capric acid (C10:0); from 15% to 28% by weight lauric acid (C12:0); and from 25% to 41% by weight stearic acid (C18:0); wherein the weight ratio of stearic acid (C18:0) to palmitic acid (C16:0) is 3.1:1 to 7:1 and the weight ratio of lauric acid (C12:0) to stearic acid (C18:0) is from 1:3 to 1:1, said percentages and ratios of acids referring to acids bound as acyl groups in glycerides in the fat composition and said percentages being based on the total weight of C8 to C24 fatty acids; and from 8% to 10% by weight CN46 triglycerides; from 10% to 22% by weight CN54 triglycerides; and from 19% to 26% by weight of total CN42 triglycerides and CN44 triglycerides, based on total triglycerides present in the composition.

The fat composition of this invention preferably has a solid fat content (SFC) with N40 of less than 10 in the unstabilized fat, preferably from 1 to 9, more preferably from 2 to 8. N40 is the SFC at 40° C. as measured using NMR on the unstabilized fat according to ISO 8292-1. A higher solid fat content at 40° C. was found to convey an undesirable waxy mouth feeling to food products when the fat composition is used.

The fat composition of this invention preferably has a solid fat content (SFC) with N20 of from 35 to 58, preferably from 37 to 57, more preferably from 40 to 56. N20 is the SFC at 20° C. as measured using NMR on the unstabilized fat according to ISO 8292-1. Such compositions have desirable processability properties and firm structure in food applications.

N30 in the fat composition is preferably from 10 to 32, preferably from 13 to 31, more preferably from 15 to 30. N30 is the SFC at 30° C. as measured using NMR on the unstabilized fat according to ISO 8292-1.

It is believed that the food product such as whipped cream or shortening have a desirable structure, melting behavior, and flavor release when they comprise a fat composition at N20 and/or N30 within the preferred ranges.

In a preferred embodiment, the fat composition of the invention comprises, consists essentially of, or consists of an interesterified fat blend comprising at least one fat selected from shea butter, shea stearin, shea olein and mixtures thereof and at least one oil selected from coconut oil, coconut oil stearin, coconut oil olein and mixtures thereof, optionally fractionated after interesterification.

In a more preferred embodiment, the fat composition of the invention comprises an interesterified fat blend of shea shearin and coconut oil. Preferably the ratio of shea stearin to coconut oil is from 30:70 to 70:30 by weight, more preferably from 45:55 to 65:35 by weight.

The fat compositions of the invention are preferably free or essentially free of palm oil, palm kernel oil and fractions thereof. By essentially free, it is meant that the content of palm oil, palm kernel oil and fractions thereof is less than 1% by weight, more preferably less than 0.5% by weight such as less than 0.1% by weight.

The invention also relates to the use of a fat composition according to the invention for a bakery application, such as in a laminated dough e.g., for puff pastry.

The fat compositions of the invention are typically suitable for use in bakery products and may be used as bakery fat. In a preferred embodiment, the fat composition may be used as bakery fats in the form of a shortening. A shortening is a product consisting of or comprising the fat composition in plasticized form. Fats can be made plastic by means of scraped surface heat exchanger (usually termed votator), for use in various bakery applications such as puff pastries, cakes, cookies, pies or croissants.

In another preferred embodiment, the bakery products have a laminated structure. For example, the fat compositions of the invention, in the form of shortening, may be used (or may be suitable for use) as laminating fats for puff pastry application. The bakery products of the invention are dough or are made from dough. The bakery products prepared according to the invention comprise the fat composition of the invention. Optionally, a fat according to the fat composition of the invention as shortening may be used for dough preparation, whereas another similar or identical fat composition according to the invention is used as a laminating fat in the same bakery product.

Bakery products preferably comprise the fat composition of the invention, flour and water. Preferably, the bakery product is in the form of a dough, which may be laminated, comprising from 30% to 70% by weight flour, from 10% to 40% by weight water and from 20% to 40% by weight of the fat composition of the invention.

The invention further relates to the use of a fat composition according to the invention for a confectionery application. Confectionery compositions comprising a fat composition of the invention typically also comprise at least sugar.

In a preferred embodiment, the fat composition of the invention is used (or may be suitable for use) for whipped cream application. The whipped cream produced using the fat composition of the invention has been found to have a smooth and light structure and desirable sensory performance with increased incorporation of air during the aeration step. Whipped cream is typically an oil-in-water emulsion that incorporates a suspended gas such as air. Whipped creams may comprise the fat composition of the invention, water and optionally one or more of sugar, skimmed milk powder and emulsifier. Typically, a whipped cream comprises 10% to 50% by weight sugar, 20% to 50% by weight fat, 10% to 40% by weight water and optionally up to 10% by weight skimmed milk powder and optionally up to 5% by weight emulsifier.

The invention also contemplates the use of the fat composition of the invention for increasing air incorporation during the formation of whipped cream. Also contemplated is the use of the fat composition of the invention for improving the texture properties, stability, and sensory performance of a whipped cream.

The invention also relates to a process for making the fat composition comprising the interesterification of a blend of at least one fat selected from shea butter, shea stearin, shea olein and mixtures thereof, preferably shea stearin; and at least one oil selected from coconut oil, coconut oil stearin, coconut oil olein and mixtures thereof, preferably coconut oil, in a weight ratio of from 30:70 to 70:30, preferably from 45:55 to 65:35. Interesterification may be carried out chemically or enzymatically and is preferably carried out chemically, for example using sodium methoxide as catalyst.

In an alternative embodiment, the fat composition of the invention can be obtained by fractionation of the interesterified blend mentioned above, preferably the interesterified blend is of shea olein and coconut oil olein, for instance the interesterified blend of shea olein and coconut oil olein in a weight ratio of from 45:55 to 65:35. The fat composition of the invention is preferably the stearin (higher melting) fraction obtained after fractionation.

The processes of the invention preferably comprise steps of bleaching and/or deodorization, typically after interesterification and any optional fractionation.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

The following non-limiting examples illustrate the invention and do not limit its scope in any way. In the examples and throughout this specification, all percentages, parts and ratios are by weight unless indicated otherwise.

### EXAMPLES

### Example 1

2185 g of a blend of 50% by weight shea stearin and 50% by weight of coconut oil was chemically interesterified using sodium methoxide as catalyst followed by bleaching and deodorization. This fat is referred to as Fat A.

2500 g of a blend of 75% by weight shea stearin and 25% by weight of coconut oil was chemically interesterified using sodium methoxide as catalyst followed by bleaching and deodorization. This fat is referred to as Comparative Fat C.

2574 g of a blend of 50% by weight palm stearin (iodine value about 35) and 50% by weight of coconut oil was chemically interesterified using sodium methoxide as catalyst followed by bleaching and deodorization. This fat is referred to as Comparative Fat D.

The analytical results of Fat A, Comparative Fat C and Comparative Fat D are shown in Table 1.

TABLE 1
Fat compositions of Fat A, Comparative
Fat C and Comparative Fat D

| | | Comparative | Comparative |
|---|---|---|---|
| | Fat A | Fat C | Fat D |
| C8:0 | 2.8 | 1.6 | 3.1 |
| C10:0 | 2.5 | 1.4 | 2.7 |
| C12:0 | 21.5 | 11.7 | 22.3 |
| C16:0 | 6.2 | 4.5 | 35.5 |
| C18:0 | 33.9 | 46 | 4.3 |
| C18:1 | 20.7 | 25.9 | 17.7 |
| C18:2 | 2.3 | 2.5 | 4.1 |
| Total Trans | 0.1 | 0.2 | 0.3 |
| SAFA | 76.9 | 71.4 | 77.9 |
| US-N10 | 78 | 83 | 75 |
| US-N20 | 51 | 62 | 49 |
| US-N30 | 18 | 38 | 18 |
| US-N40 | 2 | 15 | 0 |
| C8:0 + C10:0 | 5.3 | 3.0 | 5.8 |
| C18:0/C16:0 | 5.47 | 10.22 | 0.12 |
| C12:0/C18:0 | 0.63 | 0.25 | 5.19 |
| CN26 | 0.1 | 0 | 0 |
| CN28 | 0.3 | 0.1 | 0.1 |
| CN30 | 0.7 | 0.5 | 0.5 |
| CN32 | 1.7 | 0.5 | 1.4 |
| CN34 | 2.4 | 0.7 | 2.3 |
| CN36 | 4.2 | 1.2 | 5.7 |
| CN38 | 7.5 | 2.7 | 7.1 |
| CN40 | 6.7 | 2.5 | 11.7 |
| CN42 | 13.5 | 6.1 | 13.7 |
| CN44 | 12.4 | 8.2 | 15.2 |
| CN46 | 8.5 | 6.3 | 15.6 |
| CN48 | 19.6 | 21.6 | 11.6 |
| CN50 | 7.6 | 8.8 | 8.9 |
| CN52 | 4.2 | 7.1 | 5 |
| CN54 | 10.2 | 32 | 1.3 |
| CN56 | 0.5 | 1.6 | 0 |
| CN58 | 0 | 0.2 | 0 |
| CN42 + CN44 | 25.9 | 14.3 | 28.9 |

In the above table:
Cx:y refers to a fatty acid having x carbon atoms and y double bonds; levels determined by GC-FAME (ISO 12966-2 and ISO 12966-4)
SAFA refers to saturated fatty acids;
Trans refers to trans fatty acids;
CNxx refers to a triglyceride having xx carbon atoms; levels determined by GC with pretreatment to remove the diglycerides eventually (AOCS Ce 5-86);
US-Nx refers to solid fat content determined by NMR on 20° C. unstabilized fat at x° C. (ISO 8292-1);

The fat composition A has been found to be particularly useful as an ingredient for bakery and confectionery applications.

### Example 2

Fat A, Comparative Fat C and Comparative Fat D obtained in Example 1 were used to make whipped creams as follows.

TABLE 2
Whipped cream recipe

| Ingredient | Amount (g) |
|---|---|
| Sugar | 100 |
| Dextrose | 250 |
| Fat (Fat A or Comparative Fat C or | 350 |
| Comparative Fat D) | |
| Water | 250 |
| Skimmed milk powder | 40 |
| Emulsifier (Dimodan ® MO 90/D) | 10 |

Fat A, Comparative Fat C and Comparative Fat D were melted by using a water bath at 70° C. The emulsifier (Dimodan® MO 90/D (Danisco/DuPont)) was added to the liquid fat and further kept on the water bath until melted. The dry ingredients were weighed and mixed. Water was added into the dry ingredients mixture and then gently mixed by using a water bath at 70° C. The water phase was added to the fat phase and gently mixed by hand for 10-15 seconds. The mixture was then homogenized with a T45 Ultra-Turrax (IKA), at 10000 rpm for 2 min. The emulsion was transferred into a 1 L jerrycan and stored in the freezer (−18° C.) for 2 hours. After 2 hours, the emulsion was transferred to the refrigerator (4-6° C.) for 44 hours. The cooled emulsion was transferred into a Hobart metal bowl and whipped for 2 minutes at speed 3.

The overrun of the fillings was measured immediately after aeration by weighing the same volume of sample before and after aeration.

TABLE 3
Weights of the samples before and after aeration

| | Weight before | Weight after |
|---|---|---|
| Sample | aeration (g) | aeration (g) |
| Whipped cream by using Fat A | 104 | 63 |
| Whipped cream by using Comparative | 104 | 66.3 |
| Fat C | | |
| Whipped cream by using Comparative | 104 | 76.8 |
| Fat D | | |

Based on the results above for the same volume of sample, the overruns were calculated as following:

Overrun [%]=[(Weight before aeration (g))−Weight after aeration (g))]/(Weight after aeration (g))*100

The higher the overrun the greater the amount of air that was incorporated during whipping.

TABLE 4
Overrun (%) of the samples

| Sample | Overrun |
|---|---|
| Whipped cream by using Fat A | 65.1% |
| Whipped cream by using Comparative Fat C | 56.9% |
| Whipped cream by using Comparative Fat D | 35.4% |

The whipped cream made by using Fat A has the higher overrun and better air incorporation than the one made by using Comparative Fat C or Comparative Fat D. Also, the composition including fat A had better texture properties, good stability, and sensory performance.

### Example 3

3630 g of a blend of 65% by weight shea stearin and 35% by weight of coconut oil was chemically interesterified using sodium methoxide as catalyst followed by bleaching and deodorization. This fat is referred to as Fat B.

1335 g of a blend of 60% by weight shea olein and 40% by weight of coconut oil olein was chemically interesterified using sodium methoxide as catalyst followed by bleaching and deodorization. The obtained interesterified product was then dry fractionated at 20° C. to 22° C. using a lab-scale crystallizer. The product was first heated to 70° C. and then cooled down to 25° C. to 28° C. in 3-6 hours, held for 3-6 hours at 25° C. to 28° C. and cooled further to 20° C. to 22° C. in 5 to 10 hours and held at this temperature for 5 to 10 hours. The crystals formed were separated by means of filter pressing. The slurry was pressed using the following program: increase pressure from 0 to 20 bar in 60 minutes and squeeze 20 bar for 30 minutes. In this way, about 19% stearin yield was obtained. The stearin fraction is referred to as Fat E.

The analytical results of Fat B and Fat E are shown in Table 3.

TABLE 3
Fat compositions of Fat B and Fat E

| | Fat B | Fat E |
|---|---|---|
| C8:0 | 1.9 | 2.2 |
| C10:0 | 1.7 | 1.9 |
| C12:0 | 15.1 | 17.8 |
| C16:0 | 6 | 8.5 |
| C18:0 | 40.9 | 27 |
| C18:1 | 23.7 | 28.2 |
| C18:2 | 2.5 | 4.4 |
| Total Trans | 0.1 | 0.2 |
| SAFA | 73.7 | 66.7 |
| US-N10 | 80 | 60 |
| US-N20 | 56 | 40 |
| US-N30 | 29 | 19 |
| US-N40 | 8 | 3 |
| C8:0 + C10:0 | 3.6 | 4.1 |
| C18:0/C16:0 | 6.8 | 3.2 |
| C12:0/C18:0 | 0.37 | 0.66 |
| CN26 | 0.00 | 0.00 |
| CN28 | 0.2 | 0.2 |
| CN30 | 0.3 | 0.6 |
| CN32 | 0.8 | 0.9 |
| CN34 | 1.2 | 1.3 |
| CN36 | 2.1 | 2.5 |
| CN38 | 4.4 | 4.8 |
| CN40 | 4.1 | 4.7 |
| CN42 | 9.1 | 12.5 |
| CN44 | 10.4 | 11.2 |
| CN46 | 8.1 | 9.6 |
| CN48 | 21.8 | 20.8 |
| CN50 | 8.9 | 9.2 |
| CN52 | 6.4 | 6.9 |
| CN54 | 20.2 | 14 |
| CN56 | 1.1 | 0.8 |
| CN58 | 0.7 | 0 |
| CN42 + CN44 | 19.5 | 23.7 |

In the above table:
Cx:y refers to a fatty acid having x carbon atoms and y double bonds; levels determined by GC-FAME (ISO 12966-2 and ISO 12966-4)
SAFA refers to saturated fatty acids;
Trans refers to trans fatty acids;
CNxx refers to a triglyceride having xx carbon atoms; levels determined by GC with pretreatment to remove the diglycerides eventually (AOCS Ce 5-86);
US-Nx refers to solid fat content determined by NMR on 20° C. unstabilized fat at x° C. (ISO 8292-1);

Fats B and E according to the invention were found to be particularly suitable for producing plastic shortenings and use in bakery applications.

### Example 4

Fat B produced in Example 3 was used to make shortening at pilot scale with a micro votation equipment having an A unit−A unit−C unit−B unit configuration with a 100% throughput. In this set-up the A-unit represents a scraped surface heat exchanger, the B-unit represents the resting tube with adjustable length and C-unit stands for a pin-rotor machine as known in the art. The fat was melted in a premix tank equipped with a blade stirrer. The first A-unit and the second A-unit were set at 1200 rpm while the C-unit was set at 140 rpm. The shortening was packed under ambient conditions and stored at 16° C. for 3 days before use.

Plastic shortening was obtained with a nice structure and suitable to be used as a lamination fat. The obtained shortening was used in the preparation of puff-pastries as following:

TABLE 4
Puff-pastry recipe

| | Quantity [g] |
|---|---|
| Dough ingredients | |
| Flour | 500 |
| Water | 275 |
| Fat B | 60 |
| Salt | 5 |
| Lamination fat | |
| Fat B | 240 |

The dough was prepared and slowly kneaded with a spiral dough kneader for 8 min. Afterwards the dough was left to rest for 10 min at ambient temperature (20° C.). The lamination was conducted in two steps, ½French (3-folding) and ½Dutch (4-folding) in the first step. The dough was left to rest for 30 min at 4° C., after which the first lamination step was repeated and the dough subjected to another resting of 30 min. The thickness of the final laminated dough measured 10 mm. From this dough squared puff pastries were cut with a 93×93 mm stainless steel dough cutter. The puff pastries were baked in a conventional baking oven at 190° C. for 20 min. The shortening produced with Fat B showed good plasticity and handling during lamination. Puff pastry in which Fat B was used showed a proper lift (puff) during baking, resulting in a good product with an average height 60 mm. The product had a pleasant texture and rich taste.

1. A non-hydrogenated fat composition, comprising:
from 3.2% to 10% by weight of total caprylic acid (C8:0) and capric acid (C10:0);
from 13% to 32% by weight lauric acid (C12:0); and
from 20% to 45% by weight stearic acid (C18:0);
said percentages of acids referring to acids bound as acyl groups in glycerides in the fat composition and being based on the total weight of C8 to C24 fatty acids; and
from 7% to 15% by weight CN46 triglycerides;
from 4% to 30% by weight CN54 triglycerides; and
from 15% to 28% by weight of total CN42 triglycerides and CN44 triglycerides;
based on total triglycerides present in the composition.

2. The composition according to claim 1, wherein the composition has less than 12% by weight palmitic acid (C16:0).

3. The composition according to claim 1, wherein the composition has a weight ratio of stearic acid (C18:0) to palmitic acid (C16:0) of from 5:2 to 9:1.

4. The composition according to claim 1, wherein the composition has a weight ratio of lauric acid (C12:0) to stearic acid (C18:0) of from 1:3.5 to 2:1.

5. The composition according to claim 1, wherein the composition has:
from 3.5% to 8% by weight of total caprylic acid (C8:0) and capric acid (C10:0); and/or
from 14% to 30% by weight lauric acid (C12:0); and/or
from 23% to 43% by weight stearic acid (C18:0).

6. The composition according to claim 1 comprising:
from 8% to 12% by weight CN46 triglycerides; and/or
from 8% to 25% by weight CN54 triglycerides; and/or
from 18% to 27% by weight of total CN42 triglycerides and CN44 triglycerides,
based on total triglycerides present in the composition.

7. The composition according to claim 1, wherein the fat composition has a solid fat content (SFC) N40 of less than 10, measured on unstabilized fat according to ISO 8292-1.

8. The composition according to claim 1, wherein the fat composition has a solid fat content (SFC) N20 of from 35 to 58 as measured on the unstabilized fat according to ISO 8292-1.

9. The composition as claimed in claim 1, comprising an interesterified fat blend of at least one fat selected from shea butter, shea stearin, shea olein and mixtures thereof and at least one oil selected from coconut oil, coconut oil stearin, coconut oil olein and mixtures thereof.

10. The composition according to claim 9, wherein the composition comprises an interesterified fat blend of shea stearin and coconut oil.

11. The composition according to claim 10, wherein the ratio of shea stearin to coconut oil is from 30:70 to 70:30 by weight.

12. The method according to claim 1, wherein the composition is free or essentially free of palm oil, palm kernel oil and derivatives thereof.

13. (canceled)

14. The process for making the fat composition of claim 1, which comprises the interesterification of a blend of at least one fat selected from shea butter, shea stearin, shea olein and mixtures thereof and at least one oil selected from coconut oil, coconut oil stearin, coconut oil olein and mixtures thereof.

15. The process according to claim 14, wherein the fat and the oil are interesterified in a weight ratio of from 30:70 to 70:30.

16. The process as claimed in claim 14, wherein after interesterification, the fat composition is obtained by fractionation.
